(19) United States
(12) Patent Application Publication
(10) Pub. No.: US 2024/0239237 A1
(43) Pub. Date: Jul. 18, 2024

(54) BATTERY ASSEMBLY, ELECTRIC VEHICLE, AND METHOD FOR MONITORING BATTERY

(71) Applicants: Interface Technology (ChengDu) Co., Ltd., Chengdu (CN); INTERFACE OPTOELECTRONICS (SHENZHEN) CO., LTD., Shenzhen (CN); GENERAL INTERFACE SOLUTION LIMITED, Zhunan (TW)

(72) Inventors: CHIA-CHEN YEH, Chengdu (CN); CHING-HAO LIAO, Hsinchu (TW); ZHI-JIN GAO, Chengdu (CN)

(21) Appl. No.: 18/140,532

(22) Filed: Apr. 27, 2023

(30) Foreign Application Priority Data
Jan. 13, 2023 (CN) 202310079269.2

(51) Int. Cl. B60L 58/18; B60L 50/60; G07C 5/08; H01M 10/48; H01M 50/213

(52) U.S. Cl. CPC B60L 58/18; B60L 50/66; G07C 5/0816; H01M 10/482; H01M 10/486; H01M 50/213; B60L 2240/545; H01M 2220/20

(57) ABSTRACT

A battery assembly, an electric vehicle, and a method for monitoring battery are disclosed. The battery assembly includes a battery, a sensing part on the battery and an alarm module electrically connected to the sensing part. The sensing part is configured to generate a deformation sensing signal corresponding to a deformation of the battery. The alarm module is configured to issue an alarm when the deformation sensing signal exceeds a threshold.

### FIELD

The subject matter herein generally relates to the field of battery technologies, specifically a battery assembly, an electric vehicle, and a method for monitoring battery.

### BACKGROUND

With the development of clean energy, batteries have gradually replaced fuel energy and become one of the mainstream energy sources. For example, electric vehicles are gradually replacing fuel vehicles. However, the use environment and service life of batteries are still problems to be solved. Specifically, batteries usually swell at the end of their service life or after being accidentally damaged. Even though the volume expansion of the battery may be directly observed, the battery in such a condition is already a high risk in use. On the other hand, when a plurality of batteries forms a battery pack, the swelling state of each battery may not be easily observed. When one battery is swollen and damaged and the location of the swollen battery cannot be determined, usually the entire battery pack is discarded, resulting in an increase in cost.

Therefore, there is room for improvement in the art.

### BRIEF DESCRIPTION OF THE DRAWINGS

Implementations of the present disclosure will now be described, by way of embodiment, with reference to the attached figures.

FIG. 1 is a schematic view showing an embodiment of a device for monitoring batteries of an electronic device according to the present disclosure.

FIG. 2 is a schematic view showing another embodiment of a device for monitoring batteries of an electronic device according to the present disclosure.

FIG. 3 is a schematic view showing yet another embodiment of a device for monitoring batteries of an electronic device according to the present disclosure.

FIG. 4 is a schematic view showing yet another embodiment of a device for monitoring batteries of an electronic device according to the present disclosure.

FIG. 5 is a flowchart of a method for monitoring batteries according to an embodiment of the present disclosure.

FIG. 6 is a schematic view showing an embodiment of a battery assembly according to the present disclosure.

FIG. 7 is a schematic view showing another embodiment of a battery assembly according to the present disclosure.

FIG. 8 is a schematic view showing an embodiment of a distribution of batteries and sensing parts in a battery assembly according to the present disclosure.

FIG. 9 is a schematic view showing another embodiment of a distribution of batteries and sensing parts in a battery assembly according to the present disclosure.

FIG. 10 is a schematic view showing yet another embodiment of a distribution of batteries and sensing parts in a battery assembly according to the present disclosure.

FIG. 11 is a schematic view showing yet another embodiment of a distribution of batteries and sensing parts in a battery assembly according to the present disclosure.

FIG. 12 is a schematic view of an electric vehicle in an embodiment of the present disclosure.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the exemplary embodiments described herein. However, it will be understood by those of ordinary skill in the art that the exemplary embodiments described herein may be practiced without these specific details. In other instances, methods, procedures, and components have not been described in detail so as not to obscure the related relevant feature being described. Also, the description is not to be considered as limiting the scope of the exemplary embodiments described herein. The drawings are not necessarily to scale and the proportions of certain parts may be exaggerated to better illustrate details and features of the present disclosure.

The term “comprising” when utilized, means “including, but not necessarily limited to”; it specifically indicates open-ended inclusion or membership in the so-described combination, group, series, and the like. The disclosure is illustrated by way of example and not by way of limitation in the figures of the accompanying drawings in which like references indicate similar elements. It should be noted that references to “an” or “one” embodiment in this disclosure are not necessarily to the same embodiment, and such references can mean “at least one”. The term “circuit” is defined as an integrated circuit (IC) with a plurality of electric elements, such as capacitors, resistors, amplifiers, and the like.

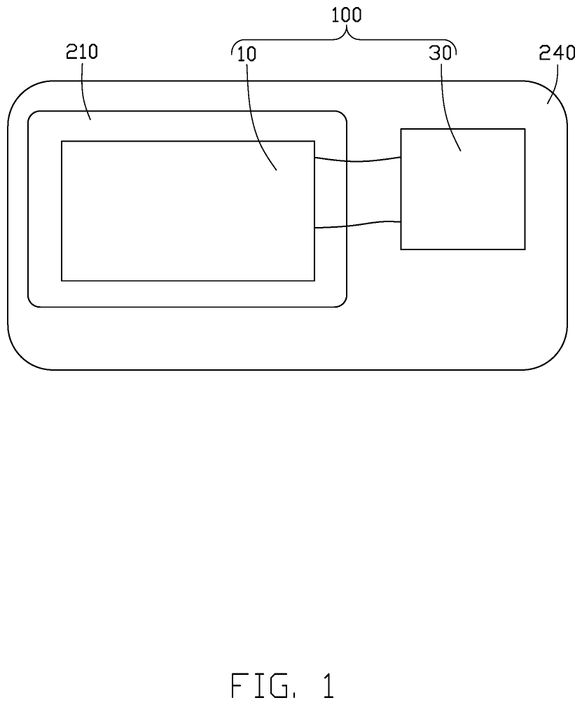

An embodiment of the present disclosure provides a device for monitoring battery. For example, the device can be used to monitor whether a battery has expanded, and whether the battery has expanded beyond a threshold, and/or to monitor a temperature of the battery and/or whether the temperature of the battery exceeds a threshold. As shown in FIG. 1, the device 100 includes a sensing layer 10 and an alarm module 30. The sensing layer 10 is on a surface of a battery 210, and configured to sense a deformation of the battery 210 and generate a deformation sensing signal corresponding to the deformation of the battery. The alarm module 30 is electrically connected to the sensing layer 10. The alarm module 30 is configured to receive the deformation sensing signal, determine whether the battery 210 has expanded and/or determine whether the deformation sensing signal exceeds a threshold, and issue an alarm if the deformation sensing signal exceeds a threshold. In one embodiment, the sensing layer 10 is made of a piezoelectric material. When the battery 210 is deformed, the battery 210 applies pressure to the sensing layer 10, and the sensing layer 10 generates different deformation sensing signals according to the magnitude of the pressure. Specifically, the sensing layer 10 can be a polymer such as polyvinylidene difluoride (PVDF) or polyvinylidene fluoride-trifluoro ethylene (P(VDF-TrFE)), or a piezoelectric ceramic. When the piezoelectric material subjected to external pressure, a voltage difference is generated at two ends of the piezoelectric material. A ratio of the pressure on the piezoelectric material to the voltage difference is called a piezoelectric constant. The formula of the piezoelectric constant can be expressed as:

$${d}_{i j} = {( \partial {S}_{j} / \partial {E}_{i} )}_{T} = {( \partial {D}_{i} / \partial {T}_{j} )}_{E} .$$

Where T is the stress applied to the piezoelectric material, S is the strain experienced by the piezoelectric material, E is the intensity of the electric field acting on the piezoelectric material, D is the electric displacement generated by the piezoelectric material, i is the direction of the electric field, and j is the direction of stress or strain. The higher the value of the piezoelectric constant dᵢⱼ, the better the piezoelectric performance of the piezoelectric material. By selecting a piezoelectric material with a suitable piezoelectric constant for the sensing layer 10, the deformation of the battery 210 can be conveniently monitored.

In one embodiment, the battery 210 is sheet shaped. The sensing layer 10 is also sheet shaped and covers the surface of the battery 210. The sensing layer 10 is a non-porous continuous layer, and the sensing layer 10 can simultaneously sense deformation of any different positions of the battery 210. The sensing layer 10 in FIG. 1 is also referred to as a sensing part.

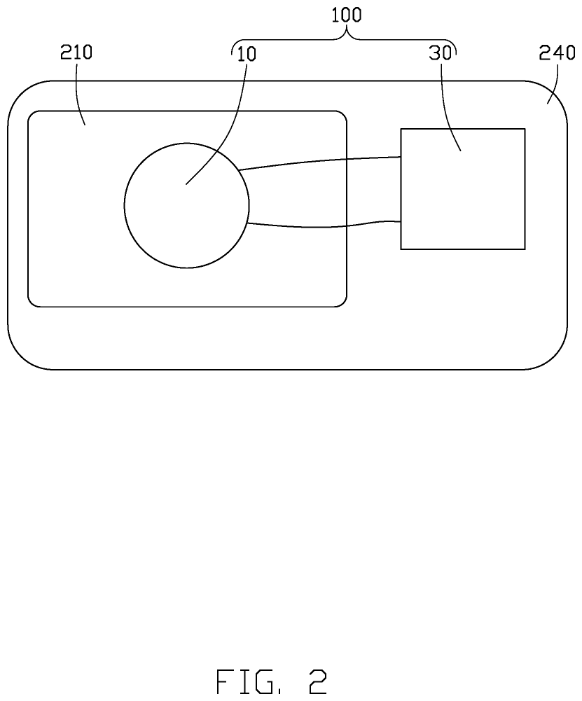

In other embodiments, as shown in FIG. 2, the battery 210 is sheet shaped. The sensing layer 10 covers the surface of the battery 210. The sensing layer 10 is a non-porous continuous layer, and has a circular shape. The circular sensing layer 10 can be placed at the position where the battery 210 is most likely to deform, thereby saving materials. The sensing layer 10 in FIG. 2 is also referred to as a sensing part.

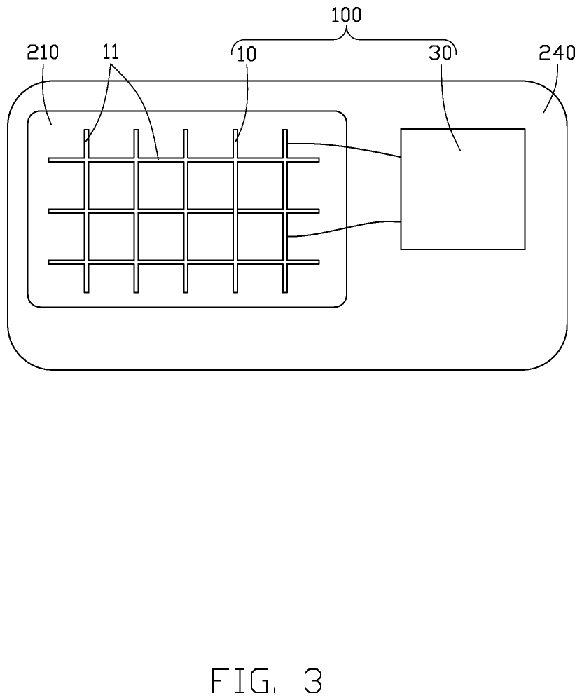

In other embodiments, as shown in FIG. 3, the battery 210 is sheet shaped. The sensing layer 10 is on the battery 210 and is mesh shaped. Specifically, the mesh-shaped sensing layer 10 is composed of a plurality of sensing lines 11 crossing each other, and all the sensing lines 11 are electrically connected. All the sensing lines 11 can be made of a same piezoelectric material layer, and the sensing lines 11 in different directions are mechanically and electrically connected at crossing positions. The sensing layer 10 as a whole is electrically connected to the alarm module 30 by two connecting wires, and the sensing layer 10 is used to transmit the deformation sensing signal of the whole battery. When the battery 210 deforms and expands, the battery 210 drives the surrounding parts to expand at the same time. Therefore, the mesh-shaped sensing layer 10 can monitor the deformation of the battery 210, and save materials while ensuring the monitoring range. The sensing layer 10 in FIG. 3 is also referred to as a sensing part.

In other embodiments, the mesh-shaped sensing layer is composed of a plurality of sensing lines crossing each other, and all the sensing lines are electrically insulated from each other. The sensing lines in different directions are independent and insulated from each other. Each sensing line of the plurality of sensing lines is individually electrically connected to the alarm module and each sensing line is used for transmitting deformation sensing signals independently. According to the position of the sensing line, the alarm module can determine the position where the battery is deformed.

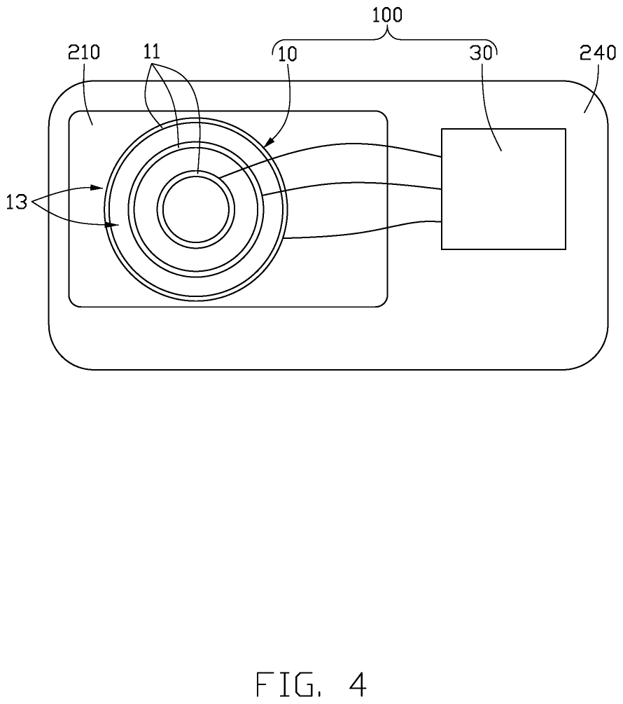

In other embodiments, as shown in FIG. 4, the battery 210 is sheet-shaped battery, the sensing layer 10 includes a plurality of circular sensing lines 11 with different radii, and the circular sensing lines 11 are concentric circles. The plurality of circular sensing lines 11 is electrically insulated from each other. Each sensing line 11 is electrically connected to the alarm module 30 independently for transmitting a respective deformation sensing signal. The plurality of sensing lines 11 divides the battery 210 into a plurality of sensing regions 13. The alarm module 30 is further configured to record a position of each sensing line, and determine a deformation region (e.g., a certain sensing region) of the battery 210 according to the deformation sensing signal sent by each independent sensing line 11. Each sensing line 11 in FIG. 4 is also referred to as a sensing part.

In other embodiments, the sensing layer 10 may include a plurality of sensing blocks (not shown), and each sensing block corresponds to a part of the battery 210 and is electrically connected to the alarm module 30 independently. The plurality of sensing blocks divides the battery 210 into a plurality of sensing regions 13. The alarm module 30 is further configured to record a position of each sensing block, and determine a deformation region (e.g., a certain sensing region) of the battery 210 according to the deformation sensing signal sent by each independent sensing block. Each sensing block is also referred to as a sensing part.

According to the structure and properties of different batteries, the sensing layer 10 can has any one of the shapes as shown in FIGS. 1 to 4, so as to better monitor whether the battery 210 swells. For example, batteries with different structures may have different locations where expansion is likely to occur, so the piezoelectric material can be concentrated on the locations where expansion is likely to be targeted. Additionally, batteries with different properties may have different degrees of deformation judged to be expansion damage. Therefore, it is possible to monitor the deformation of different positions of the battery by setting the sensing layer to include a plurality of independent sensing lines or sensing blocks, so as to determine whether the battery is swelled and damaged.

The sensing layer 10 is further configured to generate a temperature monitoring signal according to the temperature of the battery 210. Specifically, when the battery 210 is working, a part of energy of the battery 210 will be released in the form of heat, thereby increasing the temperature of the battery 210. When the battery 210 is damaged, the battery 210 usually generates more heat or does not generate heat at all. By monitoring the temperature of the battery 210, it can also be determined whether the battery 210 is working normally.

The material of the sensing layer 10 has pyroelectric properties. Specifically, when the temperature of the pyroelectric material rises, a voltage difference will be generated at two ends of the pyroelectric material, and the intensity of the voltage difference depends on the temperature. In general, piezoelectric materials have pyroelectric properties. That is, the sensing layer 10 can simultaneously generate the piezoelectric effect and the pyroelectric effect. Therefore, the output deformation of the battery 210 is the sensing signal may change under the influence of temperature when the battery 210 is working normally or not. By setting the output position of the temperature monitoring signal on the sensing layer 10, the temperature monitoring signal is not affected by the piezoelectric effect, and the influence of temperature on the deformation sensing signal can be eliminated.

The alarm module 30 can be an independent chip, or integrated into other chips. Specifically, the electronic device 240 includes the battery monitoring device 100 and the battery 210, and the electronic device 240 usually includes a central processing unit (not shown), the alarm module 30 can be directly integrated into the central processing unit, thereby improving space utilization. The electronic device 240 can be, for example, a mobile phone, a smart watch, or a wearable device.

The alarm module 30 can determine the degree of deformation of the battery 210 by the magnitude of the deformation sensing signal, thereby determining whether the battery 210 is swelled and damaged. According to different deformation degrees, the alarm module 30 can give different warnings.

Specifically, when the battery 210 is working normally, the surface of the battery 210 may be deformed to a certain extent, but the battery 210 can still be used normally at this time. As the usage time increases, the degree of deformation of the battery 210 gradually increases, eventually causing the battery 210 is damaged. During the process of the battery 210 from normal use to complete damage, the expansion of the battery 210 is a gradual process. Therefore, corresponding thresholds can be set for different expansion degrees of the battery 210, and different states of the battery 210 can be fed back by the alarm module 30.

For example, the deformation sensing signal when the sensing layer 10 is attached to the battery 210 is recorded as the initial signal. During the long-term use of the battery, the generated deformation sensing signal can be compared with the initial signal in real time. The greater the difference between the deformation sensing signal and the initial signal, the greater the deformation of the battery 210. According to the characteristics of different types of batteries 210, the alarm module 30 can correspondingly set different alarm stages, so as to facilitate determining the damage degree of the batteries 210.

The sensing layer 10 on the surface of the battery 210 of the battery monitoring device 100 can sense the degree of deformation of the battery 210, and the alarm module 30 can determine whether the battery 210 is swelled and the degree of swell, so as to sense the deformation state of the battery 210 in real time. Therefore, whether the battery is damaged can be found in time, and the safety of battery use can be improved.

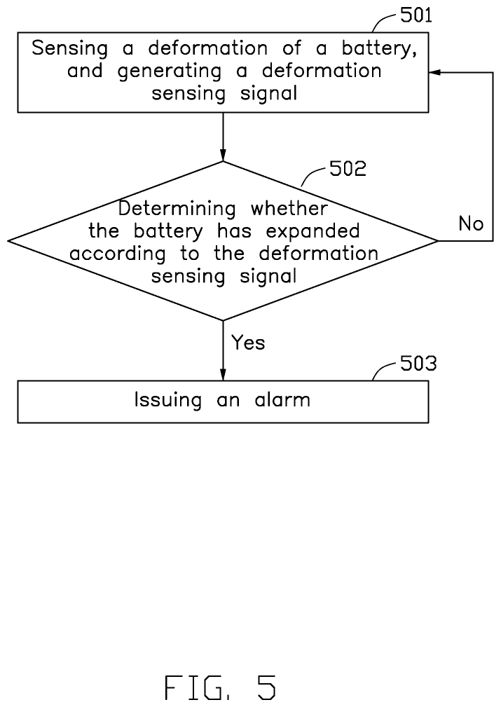

The present disclosure further provides a method for monitoring battery. Referring to FIG. 5, a flowchart is presented in accordance with an example embodiment which is being thus illustrated. The method is provided by way of embodiment, as there are a variety of ways to carry out the method. The method described below can be carried out using the configurations illustrated in FIG. 1 through FIG. 4 and FIG. 6 through FIG. 12 for example, and various elements of these figures are referenced in explaining the method. Each block in this method represents one or more processes, methods, or subroutines, carried out in the method. Additionally, the illustrated order of blocks is by example only and the order of the blocks can change. The method can begin at block 501.

In block 501, a deformation of a battery is sensed, and a deformation sensing signal corresponding to the deformation of the battery is generated.

In block 502, whether the battery has expanded is determined. Further, in block 502, whether the deformation sensing signal exceeds a threshold is determined.

In block 503, an alarm is issued.

In block 502, if the battery is not swollen or the deformation sensing signal does not exceed the threshold, continue to execute step S1. If the deformation sensing signal exceeds the threshold, step S3 is executed.

In block 501, different positions of the battery 210 are independently sensed, and the position where the battery 210 is deformed is determined. Specifically, the battery 210 can be divided into a plurality of sensing regions 13 by the shape of the sensing layer 10, and the deformation of each sensing region 13 can be sensed independently, so as to determine the deformation position of the battery 210.

Specifically, in block 502, the deformation sensing signal of the battery 210 in a normal state is obtained as an initial signal, and the subsequent deformation sensing signal is compared with the initial signal, and according to the difference between the deformation sensing signal and the initial signal, the degree of deformation of the battery 210 is determined, thereby determining whether the battery 210 is swollen.

Specifically, the normal state of the battery 210 can be the state when the battery 210 is used for the first time, or an average value of multiple normal use states of battery 210. When the battery 210 is working normally, the surface of the battery 210 may be deformed to a certain extent, but the battery 210 can still be used normally at this time. As the usage time increases, the degree of deformation of the battery 210 gradually increases, eventually causing the battery 210 is damaged. During the process of the battery 210 from normal use to complete damage, the expansion of the battery 210 is a gradual process. Therefore, corresponding thresholds can be set for different expansion degrees of the battery 210, and different states of the battery 210 can be fed back by the alarm module 30.

For example, the deformation sensing signal when the sensing layer 10 is attached to the battery 210 is recorded as the initial signal. During the long-term use of the battery, the generated deformation sensing signal can be compared with the initial signal in real time. The greater the difference between the deformation sensing signal and the initial signal, the greater the deformation of the battery 210. According to the characteristics of different types of batteries 210, the alarm module 30 can correspondingly set different alarm stages, so as to facilitate judging the damage degree of the batteries 210.

The method further includes monitoring the temperature of the battery 210 and generating a temperature monitoring signal. Specifically, when the battery 210 is working, a part of energy of the battery 210 will be released in the form of heat, thereby increasing the temperature of the battery 210. When the battery 210 is damaged, the battery 210 usually generates more heat or does not generate heat at all. By monitoring the temperature of the battery 210, it can also be determined whether the battery 210 is working normally.

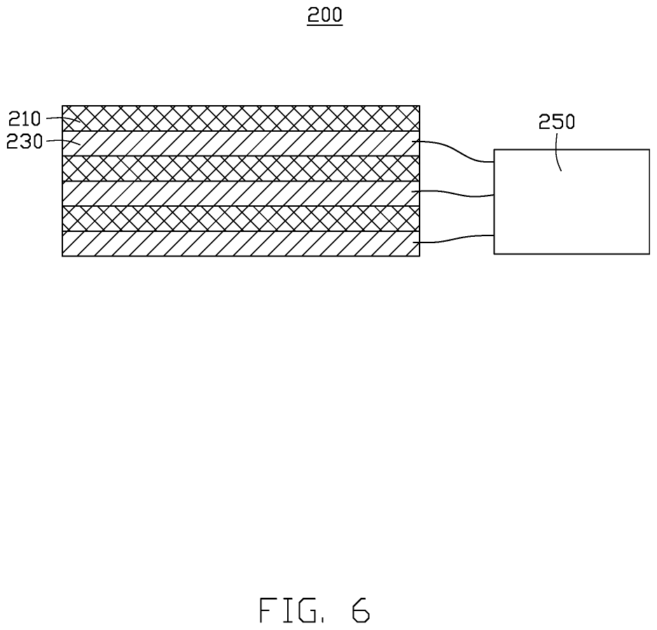

The embodiment of the present disclosure further provides a battery assembly. As shown in FIG. 6, a battery assembly 200 includes a plurality of batteries 210, a plurality of sensing parts 230 and an alarm module 250. Each sensing part 230 is between two adjacent batteries 210 for sensing deformation of the batteries 210. The alarm module 250 is electrically connected to each sensing part 230 for receiving the deformation sensing signal, determining whether the batteries 210 have expanded and whether the expansion of the batteries 210 exceeds a threshold, and issuing an alarm when the batteries 210 has expanded and the expansion of the batteries 210 exceeds a threshold.

In one embodiment, each battery 210 is sheet-shaped, each sensing part 230 also is sheet-shaped, and each battery 210 is alternated with one sensing part 230. Specifically, each sensing part 230 is used for sensing the deformation of two adjacent batteries 210, and transmits a deformation sensing signal to the alarm module 250 independently. In other embodiments, more than one battery alternates with one sensing part.

Each sensing part 230 is made of a piezoelectric material, such as PVDF or P(VDF-TrFE) or piezoelectric ceramics. While monitoring the deformation of the battery 210, sensing part 230 made of the piezoelectric material also serves as an insulating material for isolating two adjacent batteries 210. In addition, the piezoelectric material generally has low flammability, which is beneficial to improve the safety of the battery assembly 200.

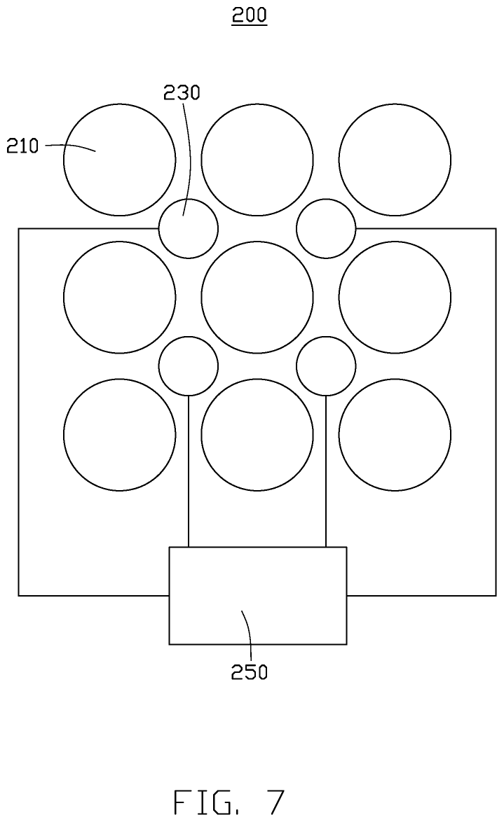

In another embodiment, as shown in FIG. 7, each battery 210 is a cylindrical battery, the plurality of batteries 210 are arranged in an array of rows and columns, and each sensing part 230 is adjacent to at least two batteries 210. Specifically, each sensing part 230 is cylindrical shaped. Each sensing part 230 is at an intersection of any two adjacent rows of the array and any two adjacent columns of the array. Each sensing part 230 is adjacent to four batteries 210, and is used to simultaneously monitor the deformation of the four batteries 210. Each battery 210 is monitored by at least one sensing part 230, and some batteries 210 are monitored by more than two (e.g., four) sensing parts 230 at the same time. Each sensing part 230 is electrically connected with the alarm module 250 independently. The alarm module 250 is further configured to record a position of each sensing part 230, and determine the position of a deformed battery by the received deformation sensing signals of different sensing parts 230.

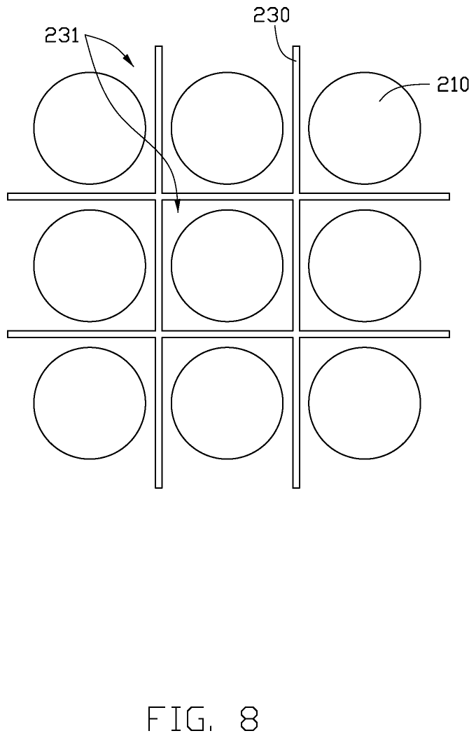

In other embodiments, the shape and quantity of the sensing parts 230 can be changed. For example, as shown in FIG. 8, the battery module includes a plurality of batteries 210 and one sensing part 230. The sensing part 230 is a mesh with a plurality of holes 231. Each hole 231 is configured to receive at least one of the batteries 210. In FIG. 8, each hole 231 receives one battery 210, but not limited to. Some batteries 210 are completely surrounded by the sensing parts 230, thus the sensing part 230 can accurately sense the deformation of the batteries 210.

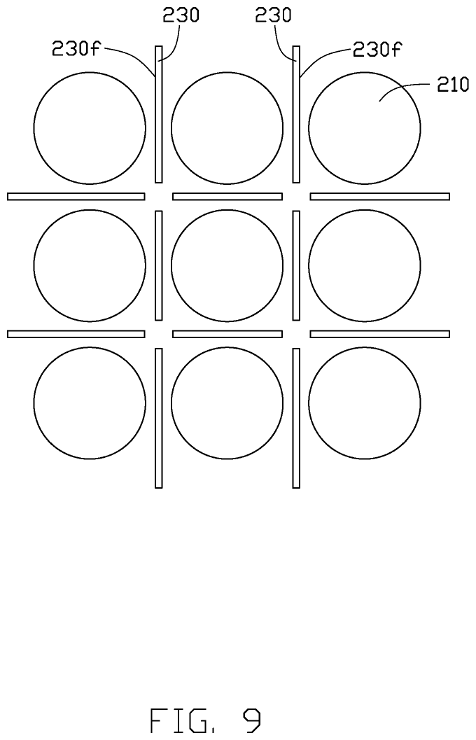

As shown in FIG. 9, the battery module includes a plurality of batteries 210 and a plurality of sensing parts 230. Each battery 210 is cylindrical shaped. Each sensing part 230 includes a flat surface 230f. The plurality of sensing parts 230 forms a network. Specifically, each sensing part 230 is between two batteries 210, and each battery 210 is at least adjacent to two sensing parts 230 and some batteries 210 are surrounded by more than two (such as four) sensing units 230. Each sensing part 230 is electrically connected to the alarm module 250 independently, so that the alarm module 250 can determine the location and direction of the swollen battery.

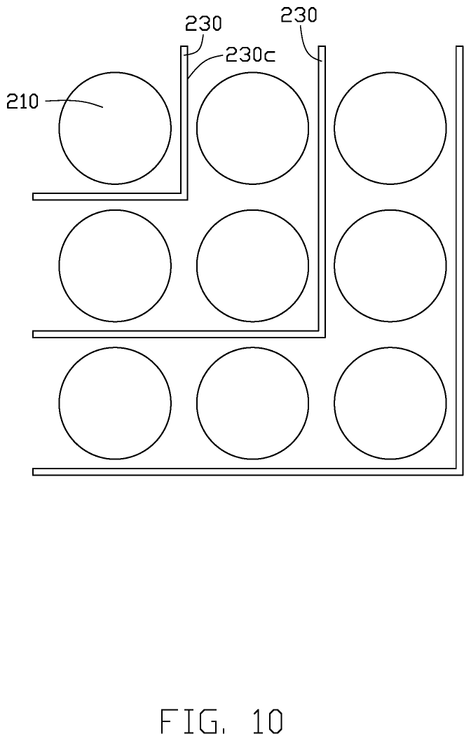

As shown in FIG. 10, the battery module includes a plurality of batteries 210 and a plurality of sensing parts 230. Each battery 210 is cylindrical shaped. Each sensing part 230 is L-shaped, which may also be referred to as curved. Each sensing part 230 has a curved surface 230c. Specifically, the plurality of sensing parts 230 divides the plurality of batteries 210 into different sensing regions. Each sensing part 230 is between at least two batteries 210. Each battery 210 is adjacent to at least one sensing part 230. Each sensing part 230 is electrically connected to the alarm module 250 independently so that the alarm module 250 can determine the location of the swollen battery.

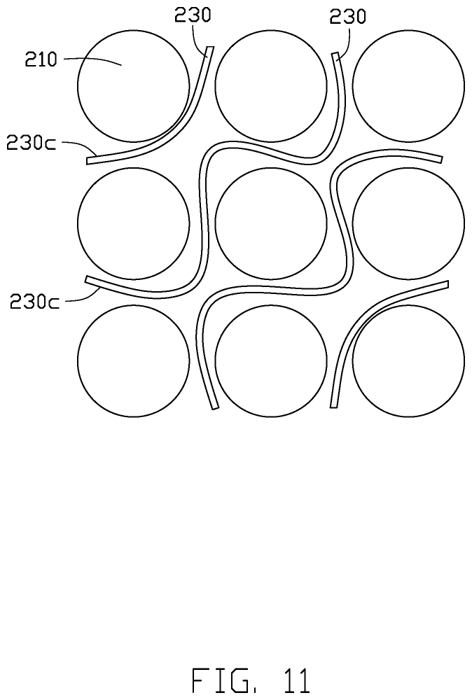

As shown in FIG. 11, the battery module includes a plurality of batteries 210 and a plurality of sensing parts 230. Each battery 210 is cylindrical shaped. Each sensing part 230 includes a curved surface. Each sensing part 230 is between at least two batteries 210. Specifically, each sensing part 230 is bent arbitrarily, so that each battery 210 is adjacent to at least one sensing part 230, and each battery 210 is provided with sensing parts 230 in at least two directions, so as to determine the position and direction of the swollen battery.

According to different models and application scenarios of the battery assembly, the sensing part can be but not limited to any one of the structures shown in FIGS. 7 to 11, so as to better monitor whether the battery is swollen.

For example, when the size of the batteries 210 in the battery assembly 200 is large and the number of the batteries 210 is small, the sensing part 230 can completely surround each battery 210, so as to accurately determine the battery 210 that has swollen. When the size of the battery 210 in the battery assembly 200 is small and the number of the batteries 210 is large (such as thousands), because the cost of a single battery 210 is low, the batteries 210 can be divided into multiple battery packs (e.g., each battery pack includes fifty batteries 210), and the sensing part 230 is between adjacent battery packs to detect the overall expansion of each battery pack, and directly replace the swollen battery pack.

The sensing part 230 is further used for generating a temperature monitoring signal according to the temperature of the battery 210. Specifically, the piezoelectric material of the sensing part 230 generally has pyroelectric properties, and when the temperature of the pyroelectric material rises, the pyroelectric effect may occur, thereby generating a voltage difference between two ends of the pyroelectric material. When the battery 210 expands and fails to work normally, it usually releases more heat than the working state, or does not release heat at all. By monitoring the temperature of the battery 210 during operation, it is also possible to determine whether the battery 210 has expanded.

That is, when the above method is applied to monitor a plurality of batteries, in block 501, a deformation sensing signal corresponding to a deformation of a plurality of adjacent batteries is generated; in block 502, a position of a deformed battery among the plurality of adjacent batteries is determined; in block 503, if the deformation sensing signal exceeds a threshold, an alarm is issued. Additionally, a temperature monitoring signal corresponding to a temperature of the at least two of the plurality of batteries is generated.

The battery assembly 200 can monitor the deformation of the batteries 210 by setting the sensing part 230, so as to determine whether the batteries 210 swell and determine the degree of expansion of the battery, which is beneficial to improve the safety of the batteries. In the embodiments in which each sensing unit 230 is electrically connected to the alarm module 250 independently, the position of the swollen battery can be determined, so that the swollen battery can be replaced in a targeted manner, which is beneficial to reduce maintenance costs.

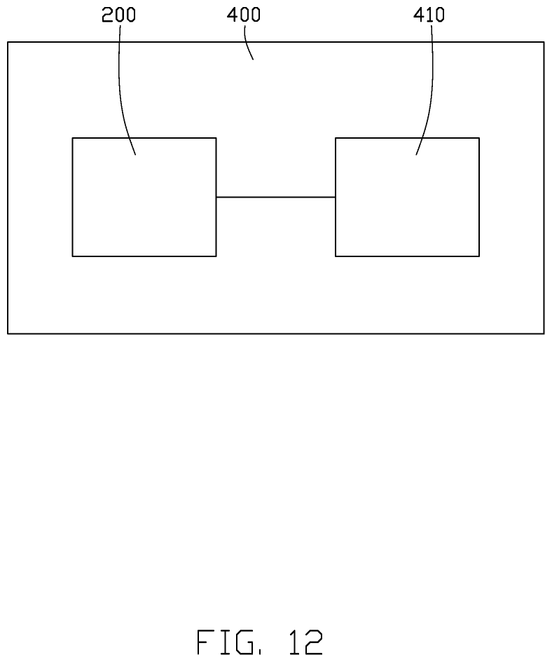

In some embodiments, an electronic device using the above battery assembly can be an electric vehicle. As shown in FIG. 12, the electric vehicle 400 includes a drive motor 410 and the battery assembly 200. The drive motor 410 is used to drive the electric vehicle 400, and the battery assembly 200 is used to provide electric energy to the drive motor 410. The battery assembly 200 can be an energy source for driving other devices (not shown) of the electric vehicle 400, such as driving-related control devices, central control systems, air-conditioning systems, and so on. The battery assembly 200 is on the rear seat or the chassis of the electric vehicle 400. The alarm module 250 can be integrated into the control terminal of the electric vehicle 400, or directly arranged on a substrate carrying the batteries 210. When the sensing part detects that a certain battery 210 is swollen or the swell exceeds the threshold, the position of the swollen battery can be displayed on the control terminal (such as the vehicle central control panel) of the electric vehicle 400, or a warning light can be turned on directly at the location of the swollen battery.

The battery assembly 200 in the electric vehicle 400 is beneficial to determine the location of the swollen battery, so that the swollen battery can be replaced in a targeted manner, which is beneficial to improving the overall service life of the battery module 200 and reducing maintenance costs.

The embodiments shown and described above are only examples. Many details are often found in the art such as the other features of a battery assembly. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size and arrangement of the parts within the principles of the present disclosure up to, and including the full extent established by the broad general meaning of the terms used in the claims. It will therefore be appreciated that the embodiments described above may be modified within the scope of the claims.

What is claimed is:

1. A battery assembly comprising:
at least one battery;
at least one sensing part on the battery, the at least one sensing part being configured to generate a deformation sensing signal corresponding to a deformation of the at least one battery; and
an alarm module electrically connected to the at least one sensing part, wherein the alarm module is configured to issue an alarm when the deformation sensing signal exceeds a threshold.

2. The battery assembly of claim 1, wherein the at least one sensing part is further configured to generate a temperature monitoring signal corresponding to a temperature of the at least one battery.

3. The battery assembly of claim 1 comprising multiple batteries and multiple sensing parts, wherein each of the multiple sensing parts is electrically connected to the alarm module independently, and the alarm module is further configured to record a position of each of the multiple sensing parts and determine a position of a deformed battery among the multiple batteries.

4. The battery assembly of claim 3, wherein each of the multiple batteries and each of the multiple sensing parts is sheet shaped, and at least one of the multiple batteries is alternated with one of the multiple sensing parts.

5. The battery assembly of claim 3, wherein each of the multiple batteries and each of the multiple sensing parts is cylindrical shaped, the multiple batteries are arranged in an array of rows and columns, and one of the multiple sensing parts is at an intersection of two adjacent rows and two adjacent columns of the array of the multiple batteries.

6. The battery assembly of claim 3, wherein each of the multiple sensing parts is a mesh with a plurality of holes, and each of the plurality of holes is configured to receive at least one of the multiple batteries.

7. The battery assembly of claim 3, wherein each of the multiple batteries is cylindrical shaped, each of the multiple sensing parts comprises a flat surface or a curved surface, and each of the multiple sensing parts is between two of the multiple batteries.

8. The battery assembly of claim 1, wherein a number of the at least one battery and a number of the at least one sensing part are both one, the battery is sheet shaped; the sensing part is a non-porous continuous layer, or the sensing part is mesh shaped.

9. The battery assembly of claim 1, wherein a number of the at least one battery is one, a number of the at least one sensing part is greater than one, the battery is sheet shaped, the at least one sensing part is electrically insulated from each other, each of the at least one sensing part is electrically connected to the alarm module independently, and the alarm module is further configured to record a position of each of the at least one sensing part and determine a deformation region of the battery.

10. An electric vehicle comprising:
a drive motor; and
a battery assembly electrically connected to the drive motor and configured for providing electric energy to the driving motor, the battery assembly comprising:
multiple batteries;
a sensing part being between at least two of the multiple batteries, the sensing part being configured to sense a deformation of the at least two of the multiple batteries and generate a deformation sensing signal; and
an alarm module electrically connected to the sensing part, wherein the alarm module is configured to receive and process the deformation sensing signal and issue an alarm when a deformation of the at least two of the multiple batteries exceeds a threshold.

11. The electric vehicle of claim 10, wherein the sensing part is further configured to generate a temperature monitoring signal corresponding to a temperature of the at least two of the multiple batteries.

12. The electric vehicle of claim 10, wherein the battery assembly comprises multiple sensing parts, each of the multiple sensing parts is electrically connected to the alarm module independently, and the alarm module is further configured to record a position of each of the multiple sensing parts and determine a position of a deformed battery among the multiple batteries.

13. The electric vehicle of claim 12, wherein each of the multiple batteries and each of the multiple sensing parts is sheet shaped, and at least one of the multiple batteries is alternated with one of the multiple sensing parts.

14. The electric vehicle of claim 12, wherein each of the multiple batteries and each of the multiple sensing parts is cylindrical shaped, the multiple batteries are arranged in rows and columns, and one of the multiple sensing parts is at an intersection of two adjacent rows and two adjacent columns of the multiple batteries.

15. The electric vehicle of claim 12, wherein each of multiple sensing parts is a mesh with a plurality of holes, and each of the plurality of holes is configured to receive at least one of the multiple batteries.

16. The electric vehicle of claim 12, wherein each of the multiple batteries is cylindrical shaped, each of the multiple sensing parts is comprises a flat surface or a curved surface, and each of the multiple sensing parts is between at least two of the multiple batteries.

17. A method for monitoring battery comprising:
generating a deformation sensing signal corresponding to a deformation of multiple adjacent batteries; and
issuing an alarm if the deformation sensing signal exceeds a threshold.

18. The method of claim 17 further comprising determining a position of a deformed battery among the multiple adjacent batteries.

19. The method of claim 17 further comprising generating a temperature monitoring signal corresponding to a temperature of the at least two of the multiple batteries.

20. The method of claim 17 further comprising determining whether deformation sensing signal exceeds the threshold.
